(19) United States
(12) Patent Application Publication
(10) Pub. No.: US 2003/0004819 A1
(43) Pub. Date: Jan. 2, 2003

(54) Anonymous email guarantor processing

(75) Inventors: Rabindranath Dutta, Austin, TX (US); Karthikeyan Ramamoorthy, Austin, TX (US)

Correspondence Address: Robert V. Wilder, Attorney at Law, 4235 Kingsburg Drive, Round Rock, TX, 78681, US

(73) Assignee: International Business Machines Corporation, Armonk, NY

(21) Appl. No.: 09/894,064

(22) Filed: Jun. 28, 2001

(51) Int. Cl. G06F 17/60; G06F 15/16

(52) U.S. Cl. 705/26; 709/206

(57) ABSTRACT

A method and implementing system are provided in which anonymous email accounts are established with a guarantor server. Items may then be loaned or purchased by an individual using the anonymous email account. In an exemplary embodiment, an individual user receives a so-called “smart card” which is programmed to contain certain limitations on purchases and/or borrowings by the user. The card is also programmed to contain the lending policies, for example, of a library. The card is read by a reading device at an enterprise such as a library or rental store for example, to determine if a desired sale or borrowing meets the guarantee criteria programmed into the smart card. If the proposed sale or borrowing is authorized or within the limits of the smart card, the transaction is approved. Any required communication between the lending enterprise and the user of the card is conducted anonymously through the anonymous email address of the user.

### FIELD OF THE INVENTION

The present invention relates generally to information processing systems and more particularly to a methodology and implementation for using anonymous email accounts in business transactions.

### BACKGROUND OF THE INVENTION

The widespread acceptance and use of various kinds of computing devices in combination with the Internet are creating an increasing number of new applications using the Internet. More and more individuals are making purchases of goods and other business transactions using the Internet. Business transactions are being initiated and completed by individuals through the use of various computing devices which may include, for example, personal computers, so-called personal digital assistant devices (PDA) and even mobile and cell-based computing devices such as mobile or cell phones.

In many instances, however, and notwithstanding many recent advances in providing increased security for business transactions conducted over the Internet, many individuals are still hesitant to provide personal credit card information to an unknown web site, lender or supplier over the Internet. At the same time, most web-based businesses, including suppliers and lenders of rental items for example, will not ship or lend a product unless sufficient personal and purchase guarantee or payment-related information about the buyer has been received.

Thus, there is a need to provide an improved method and system for enabling Internet-related transactions to be initiated and completed using an anonymous buyer account while providing a measure of payment or recourse security for the lender or seller.

### SUMMARY OF THE INVENTION

A method and implementing system are provided in which anonymous email accounts are established between a user and a guarantor server. Items may then be loaned or purchased by an individual using the anonymous email account. In an exemplary embodiment, an individual user receives a so-called “smart card” which is programmed to contain certain limitations on purchases and/or borrowings by the user as well as policies of a selling or loaning enterprise. The guarantor of the smart card maintains a record of the user and the smart card does not contain any personal information about the user but does contain the anonymous email account of the user. The programmed smart card is then read by a reading device to determine if a desired sale or borrowing meets the criteria programmed into the smart card. If the proposed sale or borrowing is authorized or within the limits of the smart card, the transaction is approved. Communication between the parties of transactions in which the card is used is conducted through use of only the anonymous email address of the user.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary system in which the present invention may be implemented;

FIG. 2 is an illustration of an arrangement of the contents of a smart card which may be used in an implementation of the present invention;

FIG. 3 is a more detailed schematic illustration of several of the system components of the exemplary embodiment;

FIG. 4 is an illustration of an exemplary anonymous server database which may be used in connection with the present invention;

FIG. 5 is an illustration of an exemplary inventory server database which may be used in connection with the present invention;

FIG. 6 is a flow diagram illustrating several exemplary steps which may be implemented in issuing a smart card to a user;

FIG. 7 is a flow diagram illustrating several exemplary steps which may be implemented in programming a user's smart card for subsequent use; and

FIG. 8 is a flow chart illustrating a methodology which may be used in one exemplary implementation of the present invention.

### DETAILED DESCRIPTION

The various methods discussed herein may be implemented within a typical computer-related system which may include a workstation or personal computer. For example, a customer may access the Internet through a server device using a personal computer, a workstation or a wireless or other portable device, all of which have the same basic computer system functionality. In the example illustrated, the customer uses a personal computer and connects to a web site through an interconnection network such as the Internet. In general, an implementing computer system may include a plurality of processors in a multi-bus system in a network of similar systems. However, since the workstation or computer system used in practicing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although a personal computer is used as an example of an implementation of the present invention, it is understood that any computing device, including but not limited to wireless devices, cell phones, PDAs or custom devices, may also be used.

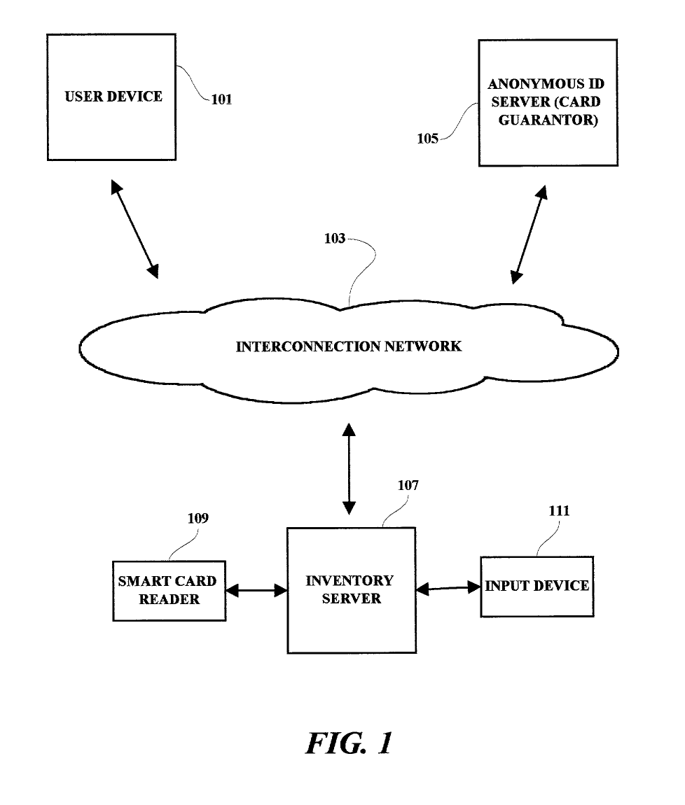

In FIG. 1, there is shown a user device 101 which may be a personal computer (PC) or a hand-held, mobile or cellular computing device capable of connecting through a connection network 103 or directly to a computer server such as, for example, a website server accessible on the World Wide Web through the Internet. In FIG. 1, there is also shown an interconnection network 103, such as the Internet, as well as an anonymous server 105, an inventory server 107 and a smart card reader 109. The inventory server 107 also includes an input device for providing input to the server 107 such as information related to a proposed user transaction. As illustrated, the user device 101, the anonymous server 105 and the inventory server 107 are all computing devices which are enabled to communicate with each other through the interconnection network 103. In the exemplary embodiment, the present invention is applied in a library environment although it is understood that the methodology and system herein disclosed may easily be applied in other business environments to accomplish the desired anonymous transactional functionality.

In the example, a user initially receives an anonymous email identification (ID) or address from the anonymous ID server 105. The user is then issued a so-called “Smart Card” by a library using the anonymous email ID as a guarantor. The card contains, in the card's memory, information concerning limits and conditions of the card as hereinafter noted. Although a “smart card” is used in the example, it is noted that this function may also be performed by any of many other portable or mobile processing devices with memory. The anonymous ID server 105, in the example, also functions as a transaction guarantor such that transactions executed by the user will be guaranteed by the issuer 105 of the anonymous email ID to the user. The user may be required by the guarantor to fund a reserve cash account, or other debit/credit account, to cover transactions made by the user up to a predetermined limit consistent with the user's cash account with the guarantor. The card will be programmed with the remaining balance of the user's account which may then be read-out at a library reader for example to ensure that a proposed transaction is fully covered by the cash account held at the anonymous ID/guarantor 105.

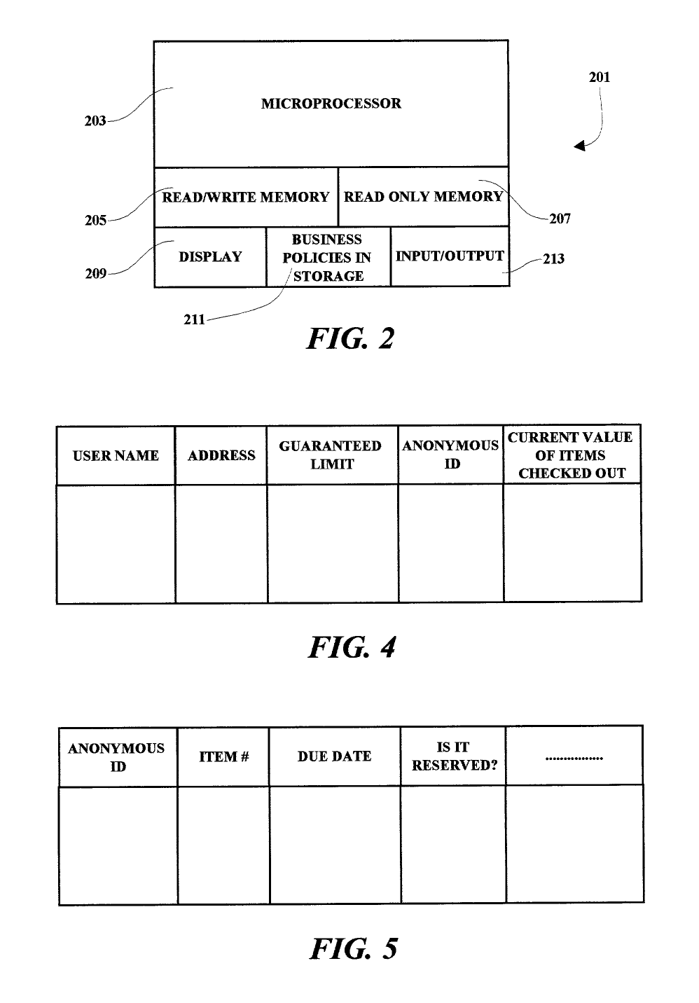

A typical smart card 201 is illustrated in FIG. 2 and may include, for example, a microprocessor 203, a read/write memory 205, a read only memory 207, a display function 209 (which may include a display device on the card), and storage area 211 for business policies and card information including the anonymous email address of the user of the card. The card 201 also contains an input/output function 213 for interfacing with card readers and other processing devices.

After receiving the anonymous email ID, the user will, in the example, have a card issued by a library for example to cover future borrowings by the user. Before the library issues the smart card, the user's identification is confirmed, for example by checking the user's driver's license. Further, the guarantor is identified to the library. The library then checks with the guarantor to insure that the information is correct and also to determine the amount of the guarantee. Several cards may be issued to cover several members of a group such as a family. The user smart card is programmed to designate limits on the card as well as other policy conditions which may be required by the library, for each card. Such programming may include, for example, the maximum number of books, CDs or other available media that may be checked out at any one time by the individual or the individual's family.

The library may also program custom policies such as the library policy regarding the rating of any material, such as “PG” or “PG13” which may be checked out by the user. For “on-line” libraries accessible through the Internet, similar information, including websites which may or may not be accessed, may be transferred or downloaded to a user's card over the Internet. Since the card is an anonymous card, and the user-specific information is located only at the anonymous ID server 105, the lending transactions at the library or over the Internet using the card are strictly anonymous and the lending transaction is accomplished between the library and an anonymous email address at the anonymous ID server 105.

When a user wishes to use the card to execute a lending transaction at a library for example, the specifics of the proposed transaction are input to the inventory server 107 through the input device 111 at the library, and the transaction specifics are compared with the data stored at the guarantee server 105, and also on the smart card as input from the reader 109. If the proposed transaction is authorized or within the policy and other limits stored on the guarantee server 105 and/or as stored on the smart card, then the transaction is approved and the smart card as well as the guarantee server 105 and the inventory server 107 are updated to include the transaction details. Thereafter, if a book or CD needs to be returned early or a loaned item is overdue, the library may correspond with the user through the anonymous email address and the user may also respond accordingly. Thus, the entire transaction and even follow-up transactions are accomplished through the use of the anonymous ID server 105 and the anonymous email address. If the loaned item is destroyed or has not been returned after a maximum time limit, the library has recourse to the anonymous ID server and guarantor 105 for appropriate compensation. The ID/guarantee server 105 is able to charge the cash account of the user for the replacement cost without identifying the user to the library. The remaining balance of the user's cash account with the anonymous ID/guarantee server 105 is then programmed into the user's smart card for future transactions.

In certain applications, the user device 101 may include a smart card I/O device (not shown) to facilitate card updating by the anonymous ID server over the Internet. In every instance that the smart card is used by the owner of the card, the interfacing computer system, for example the library computer system, checks with the guarantor server 105 to update the guarantor database with regard to the current transaction. At this time, the available guarantee balance is checked as well as the current validity of the card being used. If a transaction is requested by the user and the guarantor server database indicates that the card is no longer valid or that the covering balance in the cardholder's account is insufficient to cover the transaction, then the transaction request is declined by the guarantor server, the library is notified accordingly and the transaction is refused at the library terminal where the request for transaction was initiated.

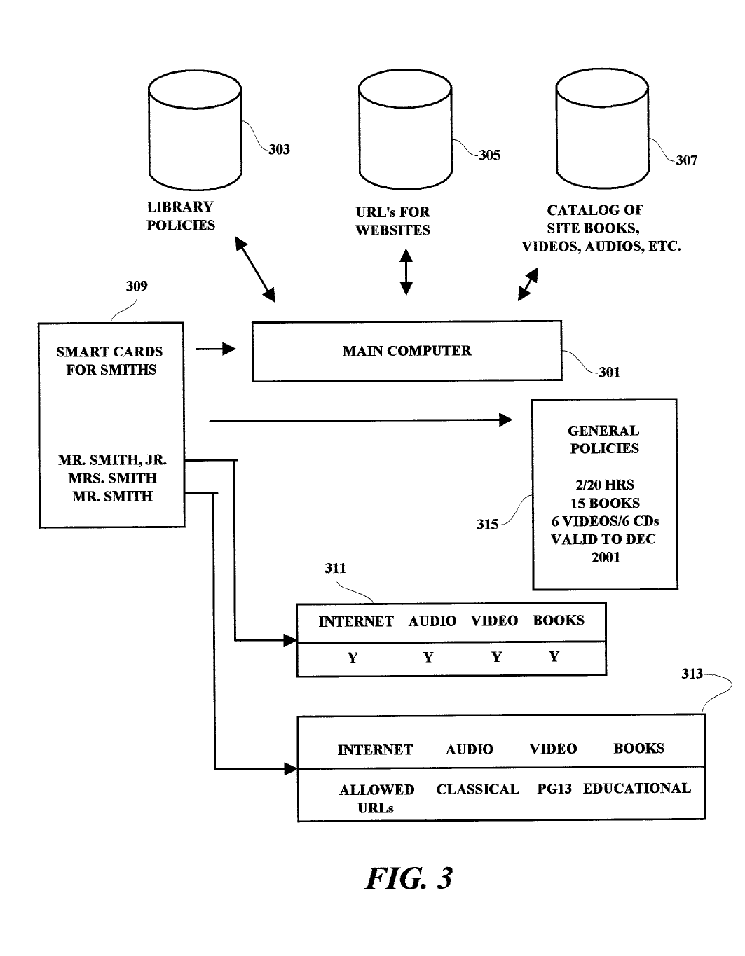

As shown in FIG. 3, a main library computer system 301 is arranged to interface with a library policy database 303, a database containing uniform resource locator (URL) addresses 305 and a catalog of site books, as well as available video and audio media 307. In the example, the “Smith” family obtains three cards 309 and the cards are programmed with the library general policies 315 such as allowed access to the library databases of 2 hours at a time for no more than 20 hours in any given month. The policies may also include for example, the limit of 15 books checked out in any given month, 6 videos and 6 audio items as well as the expiration date of the smart card. The cards are also programmed for individual limits and conditions. For example, one card may be programmed to allow unlimited access 311 to available media while another card is programmed to allow only limited access 313 to various categories of available media such as Internet, Audio, Video and Books.

As shown in FIG. 4, the anonymous server 105 contains a database which identifies each user's name, and other personal information such as, inter alia, the user's address, the guaranteed limit for transactions, the anonymous email ID and the current value of items checked out by the user. All of the information except the anonymous ID are stored in encrypted form and can be decrypted only if the user is not in good standing and attempts to recover checked-out items have failed for a continued predetermined period of time such as 60 days. This condition may be easily programmed into the ID server decrypting process as a condition precedent to allowing the decrypting function. Thus, in this example, even the anonymous server 105 cannot access the user's ID unless the user is not in good standing with the anonymous ID/guarantor 105.

As shown in FIG. 5, the inventory server database will include, inter alia, the anonymous ID of the user, as well as the item number of a checked-out item, a due date for return of the item and a field to indicate if the item has been reserved for a future date. The reservation information is used for reference if the current user wishes to extend the loan period for a given item.

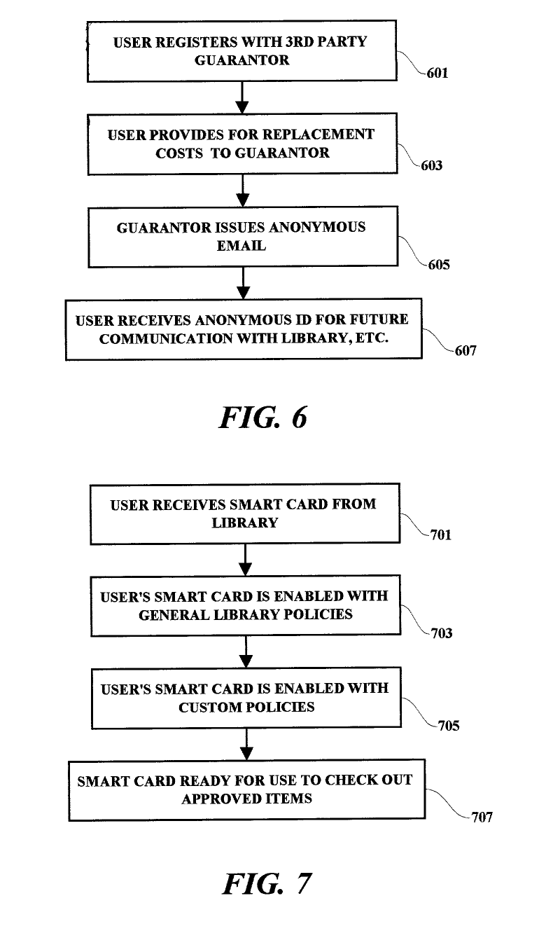

FIG. 6 illustrates the transactional flow between the user 101 and the anonymous ID/guarantor server 105. Initially, the user 101 registers with the third party guarantor 601. The user provides for replacement costs to the guarantor if necessary 603 and the guarantor then issues the anonymous email 605 which may be used by the user in future communications with the library 607 or other transactional entity. It is noted that in the present example, the anonymous ID provider and the guarantor are the same entity although those functions may also be performed by separate entities. Further, smart cards may be issued by a number of different lenders based upon the user's anonymous email ID with a single guarantor. Since the guarantor maintains an account of the replacement cost for all items checked out, the guarantor can keep track of multiple lenders with regard to the same user guarantee account.

The transactional flow between the user and the library in the present example, is illustrated in FIG. 6. After the user receives the smart card from the library 701, the card is enabled with general library policies 703 and custom policies related to the individual 705 and the smart card is then ready for use to check out approved items 707.

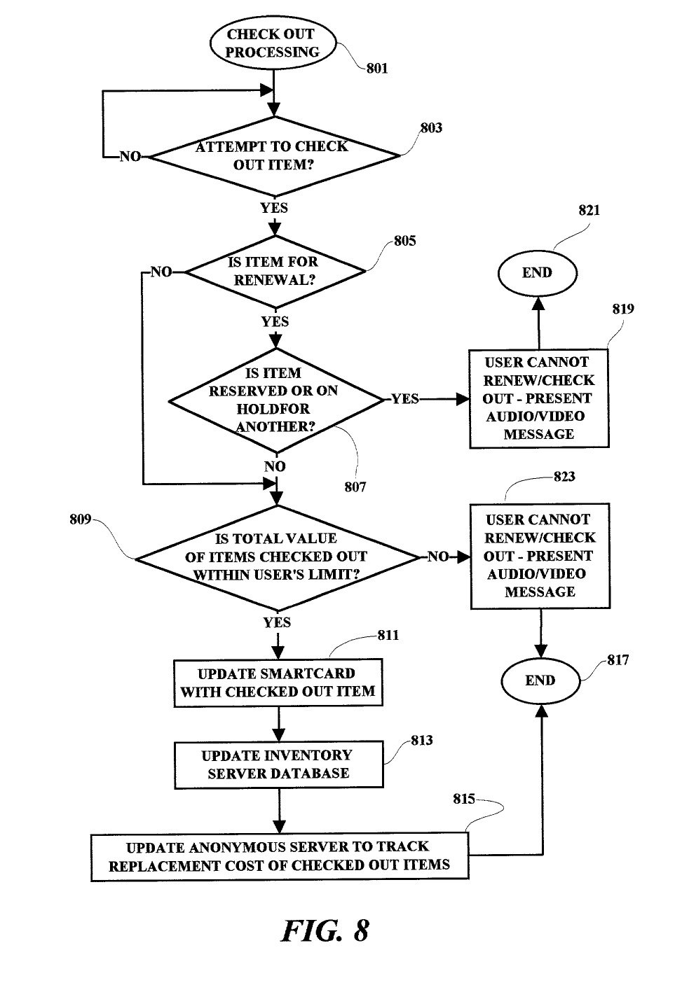

An exemplary transaction 801 is illustrated in flowchart form in FIG. 8. As shown, when a user is ready to check out loaned items from a library for example 803, a check is made to determine if the item is a renewal 805 of an item previously check out. If the request is for a renewal then a check is made to determine if there are any “holds” or reservations for the item 807. If there are reservations, the user cannot check out the item and an appropriate message is given to the user 819 and the process ends 821 for the designated item. The message may be a prerecorded audio message or a video message on a display device or a combination of audio/video presentation. If the item has not been reserved 807 or the item is not for a renewal 805, then a check is made to determine if the total value of items checked out by the user is within the user's limit 809. The user's limit information is available through access to the user's smart card. If the user is over the user's guaranteed limit then the user cannot check out the designated item and an appropriate message is presented 823, and the processing for that item is ended 817. If the user is within the guaranteed limit 809, then the smart card is updated with information concerning the checked out item 811 and the inventory server database is updated 813. The anonymous server database is also updated 815 to track replacement cost of checked out items and the remaining guarantee balance and the process is ended 817.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for guaranteeing a transaction between a user and an enterprise, said method comprising:
issuing an anonymous email address from a guarantor to said user, said user being enabled to incur an obligation associated with said transaction using said anonymous email address; and
keeping track of subsequent transactions in which said email address is used.

2. The method as set forth in claim 1 wherein said obligation is incurred for the rendering of services.

3. The method as set forth in claim 1 wherein said obligation comprises a payment for receipt of goods.

4. The method as set forth in claim 1 wherein said enterprise is a rental enterprise engaged in renting items to users.

5. The method as set forth in claim 4 wherein said rental enterprise is a media rental enterprise engaged in renting media items to users for limited periods of time, said obligation comprising a commitment to return said media items by a predetermined time.

6. The method as set forth in claim 1 wherein said enterprise is a library, said obligation comprising a promise to return items borrowed from said library.

7. The method as set forth in claim 1 and further including:
maintaining a database by said guarantor, said database containing information identifying value of items dispensed to said user from said enterprise, said obligation comprising a commitment to return or pay for said items by a predetermined time.

8. The method as set forth in claim 7 and further including:
maintaining a current account of said items, said current account including an initial value balance funded by said user less said replacement value for items currently held by said user.

9. The method as set forth in claim 1 wherein said user is enabled to incur said obligation to said enterprise based only on said email address without a disclosure of an identity of said user to said entity.

10. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being operable to effect a guaranteeing of a transaction between a user and an enterprise, said program signals being further selectively operable for:
issuing an anonymous email address from a guarantor to said user, said user being enabled to incur an obligation associated with said transaction using said anonymous email address; and
keeping track of subsequent transactions in which said email address is used.

11. The medium as set forth in claim 10 wherein said obligation is incurred for the rendering of services.

12. The medium as set forth in claim 10 wherein said obligation comprises a payment for receipt of goods.

13. The medium as set forth in claim 10 wherein said enterprise is a rental enterprise engaged in renting items to users.

14. The medium as set forth in claim 13 wherein said rental enterprise is a media rental enterprise engaged in renting media items to users for limited periods of time, said obligation comprising a commitment to return said media items by a predetermined time.

15. The medium as set forth in claim 10 wherein said enterprise is a library, said obligation comprising a promise to return items borrowed from said library.

16. The medium as set forth in claim 10 and further including:
maintaining a database by said guarantor, said database containing information identifying items dispensed to said user from said enterprise, said obligation comprising a commitment to return or pay for said items by a predetermined time, said database further including information related to replacement value for said items.

17. The medium as set forth in claim 16 wherein said program signals are further effective for:
maintaining a current account of said items, said current account including an initial value balance funded by said user less said replacement value for items currently held by said user.

18. The medium as set forth in claim 10 wherein said user is enabled to incur said obligation to said enterprise based only on said email address without a disclosure of an identity of said user to said entity.

19. A computer system arranged for processing a transaction guarantee for a transaction between a user and an enterprise, said computer system comprising:
means for issuing an anonymous email address from a guarantor to said user, said user being enabled to incur an obligation associated with said transaction using said anonymous email address; and
means for keeping track of subsequent transactions in which said email address is used.

20. A method for effecting transactions between a user and an enterprise wherein said user incurs an obligation to said enterprise, said transactions being authorized based on an anonymous email address, said method comprising:
issuing a portable processing device to said user based on said anonymous email address, said portable processing device including input and output means, processing means and memory means, said portable processing device being selectively operable for processing information related to said transaction;
programming said portable device to input predetermined conditions related to use of said portable device in effecting said transactions; and
interfacing an enterprise computing system with said portable device when said user incurs an obligation using said portable device, said portable device containing said anonymous email address of said user, said anonymous email address being accessible by said enterprise computing system for enabling anonymous communication between said enterprise computing system and said user.

21. The method as set forth in claim 20 wherein said portable device comprises a smart card.

22. The method as set forth in claim 20 wherein said interfacing is accomplished by connecting said portable device to an enterprise server system, said enterprise system server being enabled for maintaining an inventory database containing a listing of items available for dispensing in exchange for said obligation.

23. The method as set forth in claim 22 wherein said enterprise server system is further enabled for maintaining a balance of said items available after deducting items dispensed and currently in possession of said user.

24. The method as set forth in claim 23 wherein said inventory server system is further selectively operable for transmitting an identity of said items dispensed to said portable device of said user.

25. The method as set forth in claim 24 wherein said portable device is enabled to maintain in said memory means of said portable device, a listing of said items dispensed.

26. The method as set forth in claim 25 wherein said inventory server system is further enabled to maintain a record of value of said items dispensed to said user.

27. The method as set forth in claim 26 wherein said portable device is enabled to maintain a record of value of said items dispensed.

28. The method as set forth in claim 20 wherein said obligation is guaranteed by a guarantor separate from said user and said enterprise.

29. The method as set forth in claim 28 and further including notifying said guarantor by said enterprise computing system when said obligation is not fulfilled.

30. The method as set forth in claim 20 wherein said enterprise is a library, said obligation comprising a promise to return borrowed items by a predetermined time.

31. The method as set forth in claim 20 wherein said enterprise is a rental enterprise.

32. The method as set forth in claim 20 wherein said portable device contains no user identifying information, said obligation being incurred by said user based solely upon a guarantee by an issuer of said anonymous email address.

33. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective for processing transactions between a user and an enterprise wherein said user incurs an obligation to said enterprise, said transactions being authorized based solely on an anonymous email address, said program signals being further effective for accomplishing a processing method comprising:
issuing a portable processing device to said user based on said anonymous email address, said portable processing device including input and output means, processing means and memory means, said portable processing device being selectively operable for processing information related to said transaction;
programming said portable device to input predetermined conditions related to use of said portable device in effecting said transactions; and
interfacing an enterprise computing system with said portable device when said user incurs an obligation using said portable device, said portable device containing said anonymous email address of said user, said anonymous email address being accessible by said enterprise computing system for enabling anonymous communication between said enterprise computing system and said user.

34. The medium as set forth in claim 33 wherein said portable device comprises a smart card.

35. The medium as set forth in claim 33 wherein said interfacing is accomplished by connecting said portable device to an enterprise server system, said enterprise system server being enabled for maintaining an inventory database containing a listing of items available for dispensing in exchange for said obligation.

36. The medium as set forth in claim 35 wherein said enterprise server system is further enabled for maintaining a balance of said items available after deducting items dispensed and currently in possession of said user.

37. The medium as set forth in claim 36 wherein said inventory server system is further selectively operable for transmitting an identity of said items dispensed to said portable device of said user.

38. The medium as set forth in claim 37 wherein said portable device is enabled to maintain in said memory means of said portable device, a listing of said items dispensed.

39. The medium as set forth in claim 38 wherein said inventory server system is further enabled to maintain a record of value of said items dispensed to said user.

40. The medium as set forth in claim 39 wherein said portable device is enabled to maintain a record of value of said items dispensed.

41. The medium as set forth in claim 33 wherein said obligation is guaranteed by a guarantor separate from said user and said enterprise.

42. The medium as set forth in claim 41 wherein said program signals are further effective for:
notifying said guarantor by said enterprise computing system when said obligation is not fulfilled.

43. The medium as set forth in claim 33 wherein said enterprise is a library, said obligation comprising a promise to return borrowed items by a predetermined time.

44. The medium as set forth in claim 33 wherein said enterprise is a rental enterprise.

45. The medium as set forth in claim 33 wherein said portable device contains no user identifying information, said obligation being incurred by said user based solely upon a guarantee by an issuer of said anonymous email address.

46. A computer system arranged for processing transactions between a user and an enterprise wherein said user incurs an obligation to said enterprise, said transactions being authorized based solely on an anonymous email address, said computer system comprising:
means for effecting an issuing of a portable processing device to said user based on said anonymous email address, said portable processing device including input and output means, processing means and memory means, said portable processing device being selectively operable for processing information related to said transaction;
means for programming said portable device to input predetermined conditions related to use of said portable device in effecting said transactions; and
means for interfacing an enterprise computing system with said portable device when said user incurs an obligation using said portable device, said portable device containing said anonymous email address of said user, said anonymous email address being accessible by said enterprise computing system for enabling anonymous communication between said enterprise computing system and said user.
